(19) United States
(12) Patent Application Publication
(10) Pub. No.: US 2022/0360679 A1
(43) Pub. Date: Nov. 10, 2022

(54) METHOD FOR CONTROLLING IMAGE FORMING APPARATUS, IMAGE FORMING APPARATUS

(71) Applicant: KYOCERA Document Solutions Inc., Osaka (JP)

(72) Inventor: Yoshitaka Kishi, Osaka (JP)

(21) Appl. No.: 17/657,104

(22) Filed: Mar. 29, 2022

(30) Foreign Application Priority Data
May 7, 2021 (JP) 2021-078936

(51) Int. Cl. H04N 1/00; H04N 1/034

(52) U.S. Cl. CPC H04N 1/00822; H04N 1/034

(57) ABSTRACT

Images in a first drawing region on a first reading surface and in a second drawing region on a second reading surface of a both-surface targeted document satisfy both-surface targeted conditions. Images in a first drawing region on a first reading surface and in a second drawing region on a second reading surface of a non-target document satisfy non-target conditions. A processor causes a printing apparatus to execute both-surface pattern print processing for the both-surface targeted document. The processor causes the printing apparatus to execute idle feed processing for the non-target document. The both-surface pattern print processing includes processing in which a first pattern image is formed on the second reading surface and processing in which a second pattern image is formed in a region including the first drawing region on the first reading surface.

### INCORPORATION BY REFERENCE

This application is based upon and claims the benefit of priority from the corresponding Japanese Patent Application No. 2021-078936 filed on May 7, 2021, the entire contents of which are incorporated herein by reference.

### BACKGROUND

The present disclosure relates to a method for controlling an image forming apparatus which controls overlay printing to a document for preservation of confidentiality and an image forming apparatus.

It has been known that an image forming apparatus performs overlay printing to a document for the preservation of confidentiality. In addition, it has been known that the image forming apparatus prints an image pattern in accordance with a confidential level, which an image read from recording paper by a marking sensor shows, in a region of the recording paper where an image has already been formed in an overlaid manner.

### SUMMARY

A method for controlling an image forming apparatus according to one aspect of the present disclosure is a method for controlling an image forming apparatus. The image forming apparatus includes a printing apparatus which is operable to execute both-surface print processing and an image reading apparatus which is operable to execute both-surface reading processing. In the both-surface print processing, while the printing apparatus is conveying a plurality of sheets placed on a sheet placing portion one by one, the printing apparatus sequentially forms images on a first surface and a second surface of each of the sheets by an ink-jet method and further discharges each of the sheets onto a sheet discharge portion. In the both-surface print processing, the image reading apparatus reads images of both surfaces of each of a plurality of documents. The controlling method includes a processor causing the image reading apparatus to execute the both-surface reading processing. The controlling method further includes the processor identifying a first drawing region and a second drawing region which are drawing regions of a first reading surface and a second reading surface in the images of each of the documents, the images of the first reading surface and the second reading surface obtained by the both-surface reading processing. The controlling method further includes the processor identifying, from the plurality of documents, a both-surface targeted document as to which images in the first drawing region and the second drawing region satisfy predetermined both-surface targeted conditions and a non-target document which images in the first drawing region and the second drawing region satisfy predetermined non-target conditions. The controlling method further includes, in a case where the plurality of documents are placed on the sheet placing portion as the plurality of sheets with the first reading surface of each of the plurality of documents being the second surface of each of the plurality of sheets, the processor causing the printing apparatus to execute both-surface pattern print processing which is the both-surface print processing specific to the both-surface targeted document and causing the printing apparatus to perform idle feed processing in which the non-target document is discharged onto the sheet discharge portion without forming any image for the non-target document. The both-surface pattern print processing is processing in which a first pattern image is formed on the second reading surface of the both-surface targeted document and a second pattern image is further formed in a region including the first drawing region on the first reading surface of the both-surface targeted document.

An image forming apparatus according to another aspect of the present disclosure includes the printing apparatus, the image reading apparatus, and the processor.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to a first embodiment.

FIG. 2 is a configuration diagram of an image reading apparatus in the image forming apparatus according to the first embodiment.

FIG. 3 is a block diagram showing a configuration of a control device in the image forming apparatus according to the first embodiment.

FIG. 4 is a flowchart showing one example of a procedure of overlay printing control in the image forming apparatus according to the first embodiment.

FIG. 5 is a diagram showing one example of a first read image.

FIG. 6 is a diagram showing one example of a second read image.

FIG. 7 is a diagram showing one example of a second reading surface of a document on which a first pattern image is printed in an overlaid manner by the image forming apparatus according to the first embodiment.

FIG. 8 is a diagram showing one example of a first reading surface of a document on which a second pattern image is printed in an overlaid manner.

FIG. 9 is a configuration diagram of an image forming apparatus according to a second embodiment.

FIG. 10 is a flowchart showing one example of a procedure of overlay pattern printing control in the image forming apparatus according to the second embodiment.

### DETAILED DESCRIPTION

Hereinafter, with reference to the accompanying drawings, embodiments of the present disclosure will be described. It is noted that each of the embodiments described below is merely one example in which the present disclosure is embodied and does not limit the technical scope of the present disclosure.

### First Embodiment

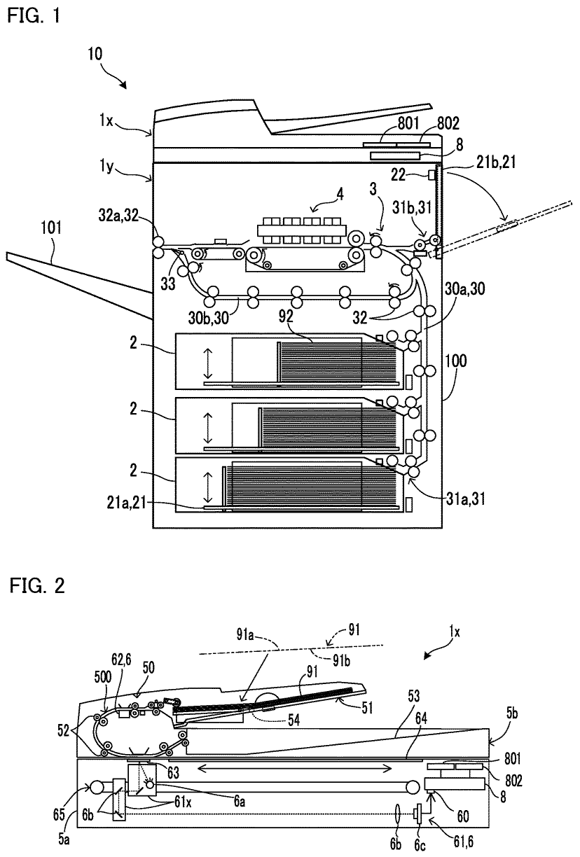

As shown in FIG. 1, an image forming apparatus 10 according to a first embodiment includes an image reading apparatus 1x, a printing apparatus 1y, a control device 8, an operation device 801, and a display device 802.

As shown in FIG. 2, the image reading apparatus 1x includes a base portion 5a and a cover portion 5b which covers an upper surface of the base portion 5a. The base portion 5a is a housing in which various kinds of devices are stored. The cover portion 5b is supported in such a way as to be displaceable between a position where the upper surface of the base portion 5a is covered and a position where the upper surface of the base portion 5a is opened.

Furthermore, the image reading apparatus 1x includes a contact glass 63 and a platen glass 64 which are disposed on the upper surface of the base portion 5a.

Furthermore, the image reading apparatus 1x includes a document conveying device 50, an image reading portion 6, a moving mechanism 65, and the like. The document conveying device 50 is incorporated into the cover portion 5b.

The document conveying device 50 includes a supply tray 51, a document conveyance path 500, a conveyance mechanism 52, a document discharge tray 53, a supplied document detection portion 54, and the like. The document conveyance path 500 is a passage of documents 91, each of which passes a surface of the contact glass 63.

The conveyance mechanism 52 sends out a plurality of documents 91 placed on the supply tray 51 one by one to the document conveyance path 500, further conveys the documents 91 along the document conveyance path 500, and further discharges the documents 91 onto the document discharge tray 53.

The image reading portion 6 reads an image formed on a document sheet 9 and executes image reading processing in which data of the read image is outputted. The image reading portion 6 is operable to execute the image reading processing for each of the documents 91 conveyed along the document conveyance path 500.

In the present embodiment, the image reading portion 6 includes a first image reading portion 61, a second image reading portion 62, and an analog front end (AFE) 60.

In the description given below, two surfaces of each of the documents 91 are referred to as a first reading surface 91a and a second reading surface 91b (see FIG. 2). Each of the documents 91 is placed on the supply tray 51 with the first reading surface 91a being an upper surface thereof and the second reading surface 91b being a lower surface thereof.

The first image reading portion 61 reads an image of the first reading surface 91a of each of the documents 91 conveyed along the document conveyance path 500. The second image reading portion 62 reads an image of the second reading surface 91b of each of the documents 91 conveyed along the document conveyance path 500.

That is, the image reading apparatus 1x is operable to execute both-surface reading processing in which images of both surfaces of each of the plurality of documents 91 are read.

In the present embodiment, each of the first image reading portion 61 and the second image reading portion 62 includes a light emitting portion 6a, a light guiding member 6b, and an image sensor 6c.

The light emitting portion 6a radiates light to each of the documents 91. The light guiding member 6b is a mirror or a lens which guides light reflected on each of the documents 91 to the image sensor 6c. The image sensor 6c is a line sensor which detects intensity of the light reflected on each of the documents 91 and outputs a detection signal as a signal of the read image.

The AFE 60 converts the signal of the read image to digital image data and outputs the image data. The digital image data is data of the read image.

In an example shown in FIG. 2, the image sensor 6c of the first image reading portion 61 is a charge coupled device (CCD) type sensor. The light emitting portion 6a and a part of the light guiding member 6b of the first image reading portion 61 are supported by a carriage 61x.

The moving mechanism 65 moves the carriage 61x over a range from a reference position facing the contact glass 63 to a position facing the platen glass 64.

In a case where each of the documents 91 is conveyed by the document conveying device 50, the moving mechanism 65 retains the carriage 61x in the reference position. When the carriage 61x is retained in the reference position, the first image reading portion 61 reads the image of the first reading surface 91a of each of the documents 91.

On the other hands, in a case where each of the documents 91 is placed on the platen glass 64, the moving mechanism 65 moves the carriage 61x along a lower surface of the platen glass 64. Thus, the first image reading portion 61 reads an image of a lower surface of each of the documents 91 on the platen glass 64.

The supplied document detection portion 54 detects each of the documents 91 placed on the supply tray 51. For example, the supplied document detection portion 54 includes a displacement member and a detection sensor, which are not shown.

By receiving a load of each of the documents 91 on the supply tray 51, the displacement member is displaced from an upper position, which is an initial position, to a lower position below the upper position. The detection sensor detects the displacement member displaced to the lower position.

The printing apparatus 1y includes a sheet housing portion 2, a sheet conveying device 3, an ink-jet recording device 4, and a sheet discharge tray 101. The sheet conveying device 3 and the ink-jet recording device 4 are disposed inside a main body housing 100.

The sheet conveying device 3 includes a sheet supply mechanism 31, a sheet conveyance path 30, a plurality of combinations of conveying rollers 32, and a route switch mechanism 33. The sheet conveyance path 30 is a passage for each of sheets 92 which extends via a print position facing the ink-jet recording device 4. The sheet housing portion 2 includes a lift plate 21a which can be displaced upward and downward.

An elevating mechanism, not shown, displaces the lift plate 21a upward and downward, thereby retaining a topmost sheet 92 on the lift plate 21a at a constant height.

Furthermore, the printing apparatus 1y includes a manual feed tray 21b and a tray close detection portion 22. Each of the lift plate 21a and the manual feed tray 21b is a sheet placing portion 21 on which a plurality of sheets 92 can be placed.

The manual feed tray 21b can be folded to a side surface of the main body housing 100. The tray close detection portion 22 detects the manual feed tray 21b folded to the side surface of the main body housing 100. That is, the tray close detection portion 22 detects the manual feed tray 21b folded to the side surface of the main body housing 100.

The detection of the manual feed tray 21b by the tray close detection portion 22 shows a situation in which the manual feed tray 21b is folded to the side surface of the main body housing 100. In a case where the sheets 92 can be placed on the manual feed tray 21b, the tray close detection portion 22 has not detected the manual feed tray 21b.

The sheet supply mechanism 31 includes a first sheet supply mechanism 31a and a second sheet supply mechanism 31b.

The first sheet supply mechanism 31a sends out the sheets 92 from the lift plate 21a to the sheet conveyance path 30 one by one. The second sheet supply mechanism 31b sends out the sheets 92 from the manual feed tray 21b to the sheet conveyance path 30 one by one.

The plurality of combinations of conveying rollers 32 are rotationally driven by a drive mechanism, not shown. The plurality of combinations of conveying rollers 32 are rotationally driven, thereby conveying the sheets 92 sent out to the sheet conveyance path 30 by the first sheet supply mechanism 31a or the second sheet supply mechanism 31b along the sheet conveyance path 30.

The ink-jet recording device 4 executes print processing for the sheets 92 conveyed by the sheet conveying device 3 by an ink-jet method. The print processing is processing in which images are formed on each of the sheets 92.

In the present embodiment, the ink-jet recording device 4 forms the images on each of the sheets 92 by water-based ink.

The sheet conveyance path 30 includes a main conveyance path 30a and a reverse conveyance path 30b. The main conveyance path 30a is a passage which extends from a carry-in entrance communicating with each of the first sheet supply mechanism 31a and the second sheet supply mechanism 31b via the print position to a discharge outlet.

The reverse conveyance path 30b is a passage which extends from a branch part between the print position on the main conveyance path 30a and a position of a discharge roller pair 32a to a converging part on an upstream side in a sheet conveying direction with respect to the print position on the main conveyance path 30a.

The discharge roller pair 32a rotates in a forward rotation direction, thereby discharging each of the sheets 92, which has passed through the print position, onto the sheet discharge tray 101. The discharge roller pair 32a rotates in a reverse rotation direction opposite to the forward rotation direction, thereby reversely conveying each of the sheets 92, which has passed through the print position. The route switch mechanism 33 guides each of the sheets 92 reversely conveyed by the discharge roller pair 32a to the reverse conveyance path 30b.

The plurality of combinations of conveying rollers 32 convey each of the sheets 92, which is guided to the reverse conveyance path 30b, along the reverse conveyance path 30b, further convey each of the sheets 92 via the converging part, and convey again each of the sheets 92 along the main conveyance path 30a.

When each of the sheets 92 is conveyed to the print position, a first surface faces the ink-jet recording device 4 and when each of the sheets 92 is conveyed via the reverse conveyance path 30b to the print position again, a second surface faces the ink-jet recording device 4.

A rotation direction of the discharge roller pair 32a is controlled and the route switch mechanism 33 is controlled, whereby the printing apparatus 1y executes one-surface print processing or both-surface print processing.

The one-surface print processing is processing in which while the plurality of sheets 92 placed on the sheet placing portion 21 are conveyed one by one, an image of each of the sheets 92 is formed on the first surface by the ink-jet method and each of the sheets 92, on which the image is formed, is further discharged onto the sheet discharge tray 101.

The both-surface print processing is processing in which while the plurality of sheets 92 placed on the sheet placing portion 21 are conveyed one by one, images are sequentially formed on the first surface and the second surface of each of the sheets 92 by the ink-jet method, and each of the sheets 92, on which the images are formed, is further discharged onto the sheet discharge tray 101. The sheet discharge tray 101 is one example of a sheet discharge portion.

The operation device 801 is a device which accepts operation of a person and includes, for example, operation buttons and a touch panel. The display device 802 is a device which displays information and includes, for example, a panel display device such as a liquid crystal display unit.

The control device 8 executes various kinds of data processing and control of the image forming apparatus 10.

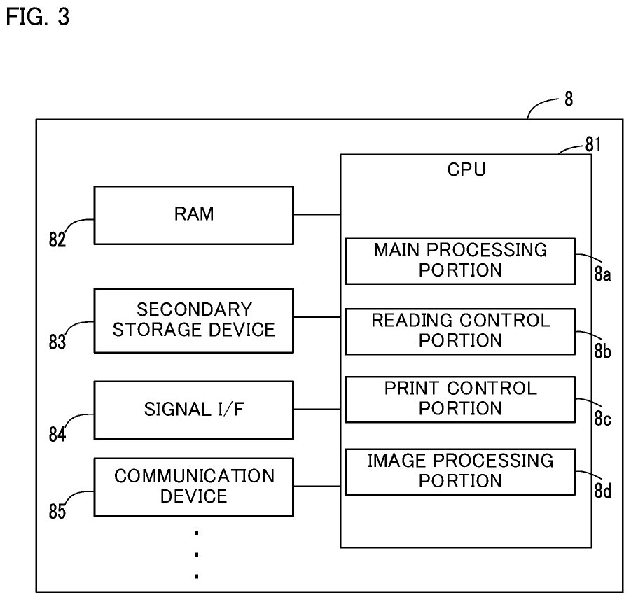

As shown in FIG. 3, the control device 8 includes a central processing unit (CPU) 81, a random access memory (RAM) 82, and peripheral devices such as a secondary storage device 83 and a signal interface 84. Furthermore, the control device 8 also includes a communication device 85 which can communicate with other devices.

The secondary storage device 83 is a computer-readable non-volatile storage device. The secondary storage device 83 is operable to store and update a computer program and various pieces of data. For example, one or both of a flash memory and a hard disc drive are adopted as the secondary storage device 83.

The signal interface 84 converts a signal outputted by each of various sensors to digital data and transmits the digital data after the conversion to the control portion 81. Furthermore, the signal interface 84 converts a control instruction outputted by the control portion 81 to a control signal and transmits the control signal to a device targeted for control.

The communication device 85 executes communication with other apparatus such as a host apparatus which transmits a print job to the image forming apparatus 10. The CPU 81 communicates with the other apparatus through the communication device 85.

The CPU 81 is a processor which executes the computer program, thereby executing various kinds of data processing and control. The RAM 82 is a computer-readable volatile storage device. The RAM 82 temporarily stores the computer program executed by the CPU 81 and data which is outputted and referenced in processes in which the CPU 81 executes the various kinds of processing.

The CPU 81 includes a plurality of processing modules which are realized by executing the computer program. The plurality of processing modules includes a main processing portion 8a, a reading control portion 8b, a print control portion 8c, an image processing portion 8d, and the like.

In accordance with operation to the operation device 801, the main processing portion 8a executes control to start various kinds of processing, control of the display device 802, and the like.

The reading control portion 8b controls the image reading apparatus 1x, thereby causing the image reading apparatus 1x to execute the both-surface reading processing. The print control portion 8c controls the printing apparatus 1y, thereby causing the printing apparatus 1y to execute the one-surface print processing or the both-surface print processing.

In addition, in a case where a pattern print mode is selected as an operation mode, the print control portion 8c causes the printing apparatus 1y to execute pattern print processing.

The pattern print processing is processing in which for preservation of confidentiality, a pattern image is printed on an image of each of the documents 91 in an overlaid manner. In a case where the pattern print mode is selected, a plurality of documents 91 are placed as a plurality of sheets 92 on the sheet placing portion 21.

The image processing portion 8d executes various kinds of image processing as to data of the read image and data targeted for the print processing.

In a case where the image forming apparatus 10 forms the image on each of the sheets 92 by the ink-jet method, the document 91 which is the sheet 92 on which the image is formed curls due to shrinkage of a surface on which the image is formed. In a case where a developer is a water-based ink, the curl of the document 91 is particularly conspicuous.

Accordingly, in a case where the pattern image for the preservation of confidentiality is further formed on the surface of each of the documents 91 on which the image has been formed, each of the documents 91 curls with a further small radius of curvature. When each of the documents 91 curls with the small radius of curvature, a jam is easily caused in the sheet conveyance path 30. Furthermore, it is hard to manage each of the documents 91, whose degree of the curl is large.

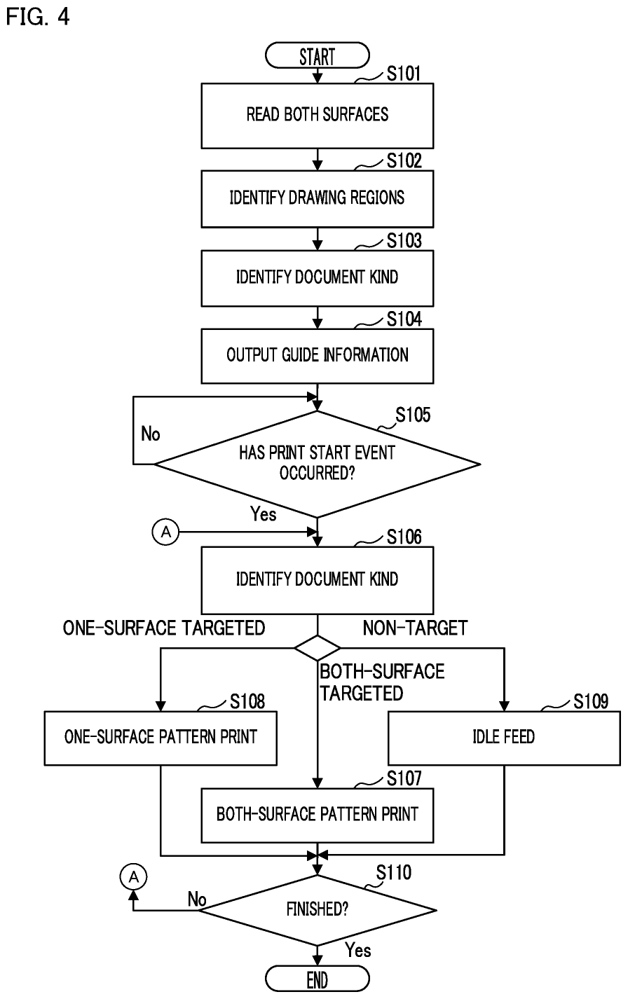

In the image forming apparatus 10, the reading control portion 8b and the print control portion 8c execute the later-described overlay printing control (see FIG. 4). Thus, further curling of each of the documents 91 can be avoided by the overlay printing for the preservation of confidentiality to each of the documents 91.

Before the overlay printing control is started, the plurality of documents 91 targeted for formation of the pattern image are placed on the supply tray 51. At that time, the plurality of documents 91 are placed on the supply tray 51 such that a front surface of each of the plurality of documents 91, on which an image is formed by the water-based ink, is the first reading surface 91a. It is noted that there may be a case where also on a rear surface of each of the plurality of documents 91, an image is formed.

When a predetermined overlay printing control start event occurs, the main processing portion 8a starts the overlay printing control. For example, the overlay printing control start event is an event in which under a situation in which the pattern print mode is selected as the operation mode and the supplied document detection portion 54 has detected leach of the documents 91 on the supply tray 51, reading start operation is performed to the operation device 801.

[Overlay Printing Control]

Hereinafter, with reference to a flowchart shown in FIG. 4, one example of a procedure of the overlay printing control will be described. The overlay printing control is one example of a method for controlling the image forming apparatus 10.

In the description given below, S101, S102, and so forth indicate identification codes of a plurality of steps in the overlay printing control. In the overlay printing control, first, processing in step S101 starts.

<Step S101>

First, in step S101, the reading control portion 8b causes the image reading apparatus 1x to execute the both-surface reading processing. Thereafter, the reading control portion 8b causes the processing to proceed to step S102.

Data of the read image of the first reading surface 91a of each of the plurality of documents 91 and data of the read image of the second reading surface 91b of each of the plurality of documents 91 can be obtained by the processing in step S101.

<Step S102>

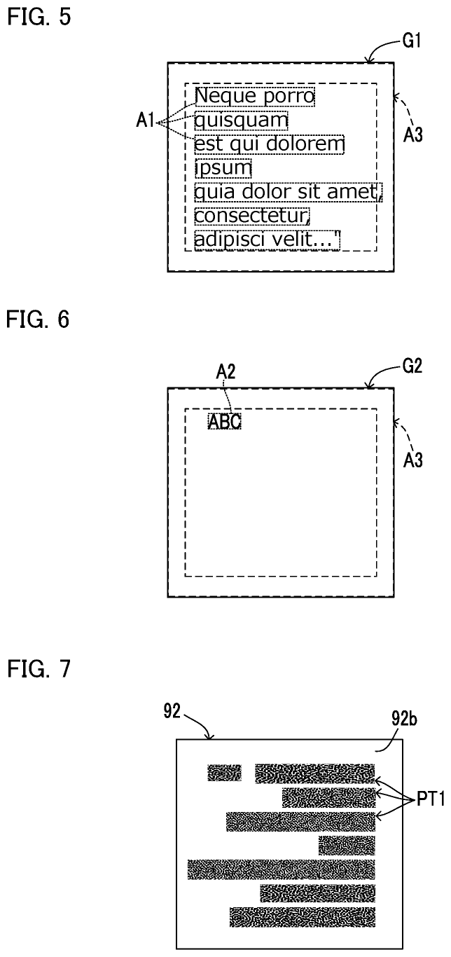

In step S102, the image processing portion 8d identifies first drawing regions A1 and a second drawing region A2 which are drawing regions in the images of the first reading surface 91a and the second reading surface 91b of each of the documents 91, which are obtained by the both-surface reading processing (see FIGS. 5 and 6).

A first read image G1 in FIG. 5 is one example of the image of the first reading surface 91a. A second read image G2 in FIG. 6 is one example of the image of the second reading surface 91b.

For example, the image processing portion 8d groups a plurality of drawing pixels in the read image into groups of pixels in a horizontal direction and a vertical direction which are present in a range of a predetermined reference distance. Furthermore, the image processing portion 8d identifies regions or a region of a circumscribed rectangle of each of the groups of the drawing pixels as first drawing regions A1 or a second drawing region A2 (see FIGS. 5 and 6).

The image processing portion 8d records drawing region data, which shows the first drawing regions A1 and the second drawing region A2 of each of the documents 91, in the secondary storage device 83. Thereafter, the image processing portion 8d causes the processing to proceed to step S103.

<Step S103>

In step S103, the image processing portion 8d executes processing in which kinds of the plurality of documents 91 are identified. In the present embodiment, the kinds of the plurality of documents 91 are three kinds, which are a both-surface targeted document, a one-surface targeted document, and a non-target document.

The both-surface targeted document is a document 91 as to which the images in the first drawing regions A1 and the second drawing region A2 satisfy predetermined both-surface targeted conditions.

The both-surface targeted conditions include first both-surface targeted conditions that an area ratio at which the first drawing regions A1 occupy the first reading surface 91a exceeds a predetermined first surface reference ratio and that an area ratio at which the second drawing region A2 occupies the second reading surface 91b falls below a predetermined second surface reference ratio.

Accordingly, the first both-surface targeted conditions include conditions that the area ratio at which the first drawing regions A1 occupy the first reading surface 91a exceeds the first surface reference ratio and that the second drawing region A2 is not present. It is noted that the second surface reference ratio is smaller than the first surface reference ratio.

Ordinarily, each of the documents 91, which satisfies the first both-surface targeted conditions, curls with the first reading surface 91a as an internal side.

In addition, the both-surface targeted conditions may further include second both-surface targeted conditions. The second both-surface targeted conditions are conditions that an area ratio at which the first drawing regions A1 occupy a predetermined marginal region A3 in the first reading surface 91a exceeds a predetermined first margin reference ratio, that an area ratio at which the second drawing region A2 occupies the second reading surface 91b falls below the second surface reference ratio, and that an area ratio at which the second drawing region A2 occupies the marginal region A3 in the second reading surface 91b falls below a predetermined second margin reference ratio.

Accordingly, the second both-surface targeted conditions include conditions that the area ratio at which the first drawing regions A1 occupy the marginal region A3 in the first reading surface 91a exceeds the first margin reference ratio and that the second drawing region A2 is not present.

For example, it is considered that the both-surface targeted conditions are conditions of a logical sum of the first both-surface targeted conditions and the second both-surface targeted conditions.

Each of the documents 91 more easily curls in a case where the image of the water-based ink is formed in the marginal region A3 than in a case where the image of the water-based ink is formed in a central region. Therefore, the second both-surface targeted conditions are adopted, thereby further surely classifying the documents 91, each of which is curled with the first reading surface 91a as the internal side, as the both-surface targeted documents.

In addition, the one-surface targeted document is each of the documents 91, as to which images in the first drawing regions A1 and the second drawing region A2 satisfy predetermined one-surface targeted conditions.

The one-surface targeted conditions are conditions that an area ratio at which the first drawing regions A1 occupy the first reading surface 91a falls below the first surface reference ratio and that the second drawing region is not present.

Each of the documents 91, which satisfies the one-surface targeted conditions, ordinarily, hardly curls even in a case the image of the water-based ink is formed in the first reading surface 91a.

On the other hands, the non-target document is each of the documents 91, as to which the images in the first drawing regions A1 and the second drawing region A2 satisfy predetermined non-target conditions.

The non-target conditions include first non-target conditions that the area ratio at which the first drawing regions occupy the first reading surface 91a exceeds the first surface reference ratio and that the area ratio at which the second drawing region occupies the second reading surface 91b exceeds a predetermined second surface reference ratio.

On each of the documents 91, which satisfies the first non-target conditions, images of the water-based ink have already been formed over wide regions of both surfaces. In a case where the pattern image is further printed in the overlaid manner, such each of the documents 91 is randomly curved, thereby easily causing the jam in the sheet conveyance path 30.

In addition, the non-target conditions may further include second non-target conditions. The second non-target conditions are conditions that the area ratio at which the first drawing regions A1 occupy the marginal region A3 in the first reading surface 91a exceeds the first margin reference ratio and that the area ratio at which the second drawing region A2 occupies the second reading surface 91b exceeds the second surface reference ratio or the area ratio at which the second drawing region A2 occupies the marginal region A3 in the second reading surface 91b exceeds the second margin reference ratio.

The image processing portion 8d records kind identification data, which shows a result of identifying each of the kinds of each of the plurality of documents 91, in the secondary storage device 83 and causes the processing to proceed to step S104.

<Step S104>

In step S104, the main processing portion 8a outputs predetermined guide information through the display device 802. The display device 802 is one example of an information output device.

The guide information is information which guides placement of the plurality of documents 91 targeted for the both-surface reading processing in step S101 onto the manual feed tray 21b with the first reading surface 91a of each of the plurality of documents 91 being the second surface of each of the plurality of sheets 92.

In accordance with the guide information, a user moves the plurality of documents 91 on the document discharge tray 53 onto the manual feed tray 21b. After outputting the guide information, the main processing portion 8a causes the processing to proceed to step S105.

Accordingly, in a case where the plurality of documents 91 are placed as the plurality of sheets 92 on the manual feed tray 21b with the first reading surface 91a of each of the plurality of documents 91 being the second surface of each of the plurality of sheets 92, processing in step S105 and subsequent processing are executed.

<Step S105>

In step S105, the main processing portion 8a stands by until a predetermined print start event occurs.

For example, the print start event is an event in which under a situation in which the tray close detection portion 22 has not detected the manual feed tray 21b, print start operation is performed to the operation device 801.

When the print start event has occurred, the main processing portion 8a causes the processing to proceed to step S106.

<Step S106>

In step S106, based on the kind identification data obtained in step S103, the print control portion 8c identifies a kind of one document 91 on the manual feed tray 21b, which is targeted for conveyance.

The print control portion 8c causes the processing to proceed to step S107 in a case where the document 91 targeted for conveyance is the both-surface targeted document, causes the processing to proceed to step S108 in a case where the document 91 targeted for conveyance is the one-surface targeted document, and causes the processing to proceed to step S109 in a case where the document 91 targeted for conveyance is the non-target document.

<Step S107>

In step S107, the print control portion 8c causes the printing apparatus 1y to execute both-surface pattern print processing, which is the specific both-surface print processing specific to the both-surface targeted document.

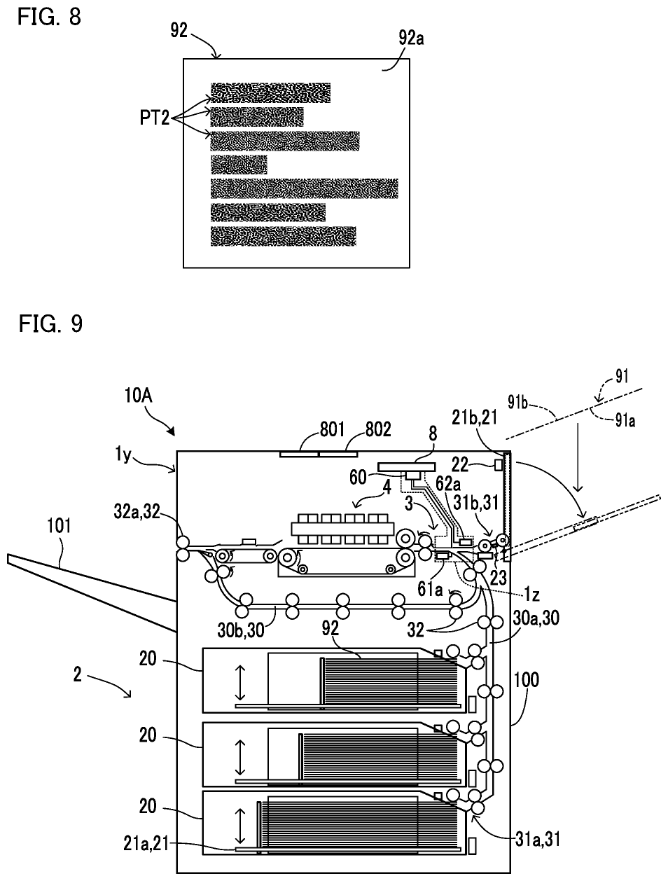

The both-surface pattern print processing is processing in which first pattern images PT1 are formed on the second reading surface 91b of the both-surface targeted document and further second pattern images PT2 are formed in a region which include the first drawing region on the first reading surface 91a of the both-surface targeted document (see FIGS. 7 and 8).

The both-surface pattern print processing for the both-surface targeted document on which the second drawing region A2 is not present includes the below-described first print processing and second print processing subsequent to the first print processing.

The first print processing is processing in which in regions overlapping the first drawing regions A1 of the first reading surface 91a on the second reading surface 91b of the both-surface targeted document, the first pattern images PT1 are formed (see FIG. 7). The second print processing is processing in which in regions including the first drawing regions A1 on the first reading surface 91a of the both-surface targeted document, the second pattern images PT2 are formed (see FIG. 8).

On the other hands, the both-surface pattern print processing for the both-surface targeted document on which the second drawing region A2 is present includes a third print processing and a fourth print processing subsequent to the third print processing.

The third print processing is processing in which in the region overlapping the first drawing region of the first reading surface on the second reading surface of the both-surface targeted document and the region including the second drawing region on the second reading surface of the both-surface targeted document, the first pattern images are formed. The fourth print processing is the same processing as the second print processing.

In step S107, first, the first pattern images PT1 are formed on the second reading surface 91b of the both-surface targeted document (see FIG. 7). The formation of the first pattern images PT1 shrinks the second reading surface 91b of the both-surface targeted document, and curling with the first reading surface 91a of the both-surface targeted document as the internal side is alleviated.

Subsequently, in a state in which the curling of the both-surface targeted document is alleviated, the second pattern images PT2 are formed on the first reading surface 91a of the both-surface targeted document (see FIG. 8). Thus, curling of the both-surface targeted document with the small radius of curvature by the formation of the second pattern images PT2 is avoided.

The both-surface pattern print processing is processing in which the first pattern images PT1 are formed on the second reading surface 91b of the both-surface targeted document and in the regions including the first drawing region on the first reading surface 91a of the both-surface targeted document, the second pattern images PT2 are formed (see FIGS. 7 and 8).

In step S107, first, the first pattern images PT1 are formed on the second reading surface 91b of the both-surface targeted document (see FIG. 7). The formation of the first pattern images PT1 shrinks the second reading surface 91b of the both-surface targeted document and alleviates the curling with the first reading surface 91a of the both-surface targeted document as the internal side.

Subsequently, in a state in which the curling of the both-surface targeted document is alleviated, the second pattern images PT2 are formed on the first reading surface 91a of the both-surface targeted document (see FIG. 8). Thus, the curling of the both-surface targeted document with the small radius of curvature by the formation of the second pattern images PT2 is avoided.

<Step S108>

In step S108, the print control portion 8c causes the printing apparatus 1y to execute one-surface pattern print processing which is the one-surface print processing specific to the one-surface targeted document.

The one-surface pattern print processing is processing in which without forming any image on the second reading surface 91b of the both-surface targeted document, in regions including the first drawing region on a first reading surface 91a of the one-surface targeted document, the second pattern images PT2 are further formed.

In step S108, first, the one-surface targeted document which has no image formed thereon passes via the main conveyance path 30a and the reverse conveyance path 30b and is conveyed to the main conveyance path 30a again.

Subsequently, the second pattern images PT2 are formed on the first reading surface 91a of the one-surface targeted document.

First drawing regions A1 of the first reading surface 91a of the one-surface targeted document are small. Therefore, the one-surface targeted document hardly curls. Furthermore, a second drawing region A2 of the second reading surface 91b of the one-surface targeted document is not present. Therefore, it is not required to form first pattern images PT1 on the second reading surface 91b of the one-surface targeted document.

<Step S109>

In step S109, the print control portion 8c causes the printing apparatus 1y to execute idle feed processing for the non-target document.

The idle feed processing is processing in which without forming any image on the non-target document, the non-target document is discharged onto the sheet discharge tray 101.

The non-target document is a document 91 having both surfaces on which images are formed in comparatively wide regions thereof. Therefore, when the first pattern images PT1 or the second pattern images PT2 are further formed on the non-target document, it is likely that the non-target document is randomly curved. The randomly curved document 91 easily causes a jam in the sheet conveyance path 30.

Accordingly, the non-target document is excluded from a target for formation of the first pattern images PT1 or the second pattern images PT2 for the preservation of confidentiality.

In addition, in step S109, in a manner different from a manner in which the discharge processing of the both-surface targeted document in the both-surface pattern print processing is performed, the print control portion 8c causes the printing apparatus 1y to perform discharge processing of the non-target document in the idle feed processing.

For example, when in the idle feed processing, the non-target document is discharged onto the sheet discharge tray 101, the print control portion 8c rotates the discharge roller pair 32a at a speed which is different from a rotational speed at which the discharge roller pair 32a is rotated when the both-surface targeted document is discharged in the both-surface pattern print processing. Thus, the non-target document is stacked in a position on the sheet discharge tray 101, which is different from a position where the both-surface targeted document is stacked.

In addition, there may be a case where the printing apparatus 1y includes a plurality of carrying-out passages, a plurality of combinations of discharge roller pairs 32a which correspond to the plurality of carrying-out passages, and a plurality of sheet discharge trays 101. In this case, the print control portion 8c may cause the printing apparatus 1y to execute processing in which the non-target document in the idle feed processing is discharged onto a discharge destination which is different from a discharge destination onto which the both-surface targeted document in the both-surface pattern print processing is discharged.

It is noted that in step S108, in the same manner of the discharge processing in which the both-surface targeted document in the both-surface pattern print processing is discharged, the print control portion 8c causes the printing apparatus 1y to perform discharge processing in which the one-surface targeted document in the one-surface pattern print processing is discharged.

It is made easy to handle the non-target document excluded from the overlay printing for the preservation of confidentiality in distinction from other documents 91 by the above-described processing.

After executing the processing in step S107, step S108, or step S109, the print control portion 8c causes the processing to proceed to step S110.

<Step 5110>

In step S110, the print control portion 8c determines whether or not the processing for all the documents 91 has been finished.

For example, when a number of documents 91 targeted for the processing in step S106 to S109 has reached a number of documents 91 targeted for the both-surface reading processing in step S101, the print control portion 8c determines that the processing for all the documents 91 has been finished.

In a case where it is determined that the processing for all the documents 91 has been finished, the print control portion 8c finishes the overlay printing control, and in a case where it is determined that the processing for all the documents 91 has not been finished, the print control portion 8c causes the processing to proceed to step S106.

According to the present embodiment, further curling of the documents 91 can be avoided by the overlay printing onto the documents 91 for the preservation of confidentiality.

### Second Embodiment

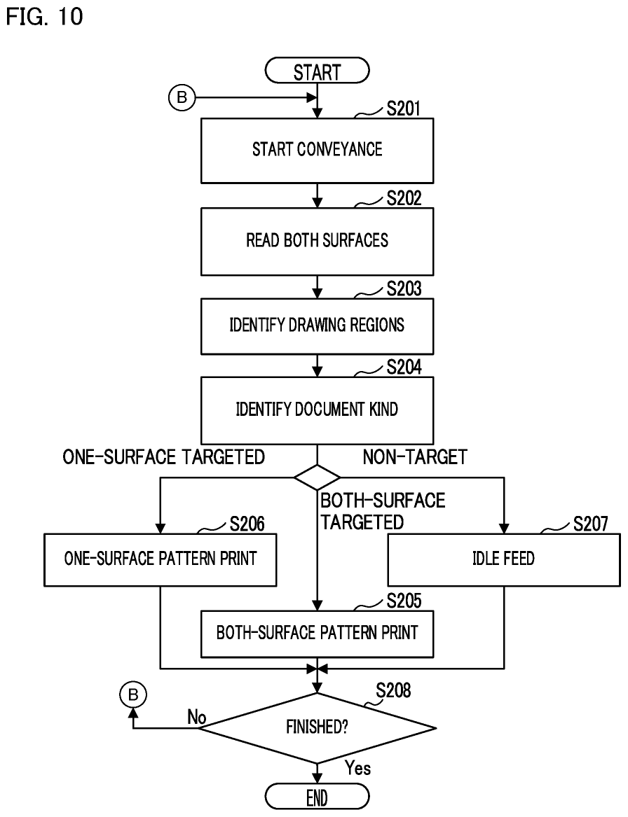

Next, with reference to FIGS. 9 and 10, an image forming apparatus 10A according to a second embodiment will be described. In FIG. 9, the same constituent components as those shown in FIG. 1 are denoted by the same reference signs.

The image forming apparatus 10A has a configuration in which the image reading apparatus 1x in the image forming apparatus 10 is replaced with an image reading apparatus 1z. Furthermore, the image forming apparatus 10A includes a supplied document detection portion 23 which detects a document 91 placed on a manual feed tray 21b.

The image reading apparatus 1z includes a first image reading portion 61a, a second image reading portion 62a, and an AFE 60. The first image reading portion 61a and the second image reading portion 62a correspond to the first image reading portion 61 and the second image reading portion 62 in the image reading apparatus 1x, respectively.

The first image reading portion 61a reads an image of a first reading surface 91a of a document 91 conveyed from a manual feed tray 21b to a main conveyance path 30a. The second image reading portion 62a reads an image of a second reading surface 91b of the document 91 conveyed from the manual feed tray 21b to the main conveyance path 30a.

The AFE 60 coverts a signal of the read image obtained by each of the first image reading portion 61a and the second image reading portion 62a to digital image data and outputs the image data. That is, as with the image reading apparatus 1x, the image reading apparatus 1z is operable to execute the both-surface reading processing for a plurality of documents 91.

In the present embodiment, when a predetermined pattern print start event has occurred, a main processing portion 8a starts overlay pattern printing control. The overlay pattern printing control corresponds to the overlay printing control in the first embodiment.

For example, the pattern print start event is an event in which under a situation in which the supplied document detection portion 23 has detected the document 91 on the manual feed tray 21b, print start operation has been made to an operation device 801.

Before starting the overlay pattern printing control, the plurality of documents 91 are placed on the manual feed tray 21b such that the first reading surface 91a is the second surface of each of the plurality of sheets 92 (see FIG. 9).

[Overlay Pattern Printing Control]

Hereinafter, with reference to a flowchart shown in FIG. 10, one example of a procedure of the overlay pattern printing control will be described. The overlay pattern printing control is one example of a method for controlling the image forming apparatus 10A.

In the description given below, S201, S202, and so forth indicate identification codes of a plurality of steps in the overlay pattern printing control. In the overlay pattern printing control, first, processing in step S201 starts.

<Step S201>

In step S201, a print control portion 8c causes a printing apparatus 1y to start conveyance of each of the documents 91 on the manual feed tray 21b. Thereafter, the print control portion 8c causes the processing to proceed to step S202.

<Step S202>

In step S202, the reading control portion 8b causes the image reading apparatus 1z to execute the both-surface reading processing. Thereafter, the reading control portion 8b causes the processing to proceed to step S203. Step S202 corresponds to step S101 in FIG. 4.

Data of the read image of the first reading surface 91a of each of the plurality of documents 91 and data of the read image of the second reading surface 91b of each of the plurality of documents 91 are obtained by the processing in step S202.

<Step S203>

In step S203, as in step S102, an image processing portion 8d identifies first drawing regions A1 and a second drawing region A2 of the images of the first reading surface 91a and the second reading surface 91b of each of the documents 91, which are obtained by the both-surface reading processing (see FIGS. 5 and 6). Thereafter, the image processing portion 8d causes the processing to proceed to step S204.

<Step S204>

In step S204, as in step S103, the image processing portion 8d executes processing in which a kind of each of the documents 91 conveyed is identified. There are three kinds of each of the documents 91, which are the both-surface targeted document, the one-surface targeted document, and the non-target document.

In a case where each of the documents 91 is identified as the both-surface targeted document, the image processing portion 8d causes the processing proceed to step S205; in a case where each of the documents 91 is identified as the one-surface targeted document, the image processing portion 8d causes the processing proceed to step S206; and in a case where each of the documents 91 is identified as the non-target document, the image processing portion 8d causes the processing proceed to step S207.

<Step S205>

In step S205, as in step S107, the print control portion 8c causes the printing apparatus 1y to execute the both-surface pattern print processing for the both-surface targeted document.

<Step S206>

In step S206, as in step S108, the print control portion 8c causes the printing apparatus 1y to execute the one-surface pattern print processing for the one-surface targeted document.

<Step S207>

In step S207, as in step S109, the print control portion 8c causes the printing apparatus 1y to execute the idle feed processing for the non-target document.

After executing the processing in step S205, step S206, or step S207, the print control portion 8c causes the processing proceed to step S208.

<Step S208>

In step S208, the print control portion 8c determines whether or not the processing for all the documents 91 has been finished.

For example, in a case where the supplied document detection portion 23 has not detected any document 91 on the manual feed tray 21b, the print control portion 8c determines that the processing for all the documents 91 has been finished.

In a case where it is determined that the processing for all the documents 91 has been finished, the print control portion 8c finishes the overlay pattern printing control, and in a case where it is determined that the processing for all the documents 91 has not been finished, the print control portion 8c causes the processing to proceed to step S201.

By adopting the image forming apparatus 10A, as in a case where the image forming apparatus 10 is adopted, further curling of each of the documents 91 can be avoided by the overlay printing for the preservation of confidentiality onto each of the documents 91.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A method for controlling an image forming apparatus,
the image forming apparatus including
a printing apparatus being operable to execute both-surface print processing, and
an image reading apparatus being operable to execute both-surface reading processing, wherein
in the both-surface print processing, while the printing apparatus is conveying a plurality of sheets placed on a sheet placing portion one by one, the printing apparatus sequentially forms images on a first surface and a second surface of each of the sheets by an ink-jet method and further discharges each of the sheets onto a sheet discharge portion, and
in the both-surface reading processing, the image reading apparatus reads images on both surfaces of each of a plurality of documents,
the method for controlling the image forming apparatus comprising:
a processor causing the image reading apparatus to execute the both-surface reading processing;
the processor identifying a first drawing region and a second drawing region which are drawing regions of a first reading surface and a second reading surface in the images of each of the documents, the images of the first reading surface and the second reading surface obtained by the both-surface reading processing;
the processor identifying, from the plurality of documents, a both-surface targeted document as to which images in the first drawing region and the second drawing region satisfy predetermined both-surface targeted conditions and a non-target document as to which images in the first drawing region and the second drawing region satisfy predetermined non-target conditions; and
in a case where the plurality of documents are placed on the sheet placing portion as the plurality of sheets with the first reading surface of each of the plurality of documents being the second surface of each of the plurality of sheets, the processor causing the printing apparatus to execute both-surface pattern print processing which is the both-surface print processing specific to the both-surface targeted document and causing the printing apparatus to perform idle feed processing in which the non-target document is discharged onto the sheet discharge portion without forming any image for the non-target document, wherein
the both-surface pattern print processing is processing in which a first pattern image is formed on the second reading surface of the both-surface targeted document and a second pattern image is further formed in a region including the first drawing region on the first reading surface of the both-surface targeted document.

2. The method for controlling an image forming apparatus according to claim 1, wherein the both-surface pattern print processing in a case where the second drawing region is not present on the second reading surface of the both-surface targeted document includes
processing in which the first pattern image is formed in a region overlapping the first drawing region of the first reading surface on the second reading surface of the both-surface targeted document and processing in which the second pattern image is formed in a region including the first drawing region on the first reading surface of the both-surface targeted document.

3. The method for controlling an image forming apparatus according to claim 1, wherein the both-surface targeted conditions include conditions that an area ratio at which the first drawing region occupies the first reading surface exceeds a predetermined first surface reference ratio and that the second drawing region is not present, and
the non-target conditions include conditions that the area ratio the first drawing region occupies the first reading surface exceeds the first surface reference ratio and that an area ratio at which the second drawing region occupies the second reading surface exceeds a predetermined second surface reference ratio.

4. The method for controlling an image forming apparatus according to claim 3, wherein the both-surface targeted conditions further include conditions that an area ratio at which the first drawing region occupies a predetermined marginal region on the first reading surface exceeds a predetermined first margin reference ratio and that the second drawing region is not present.

5. The method for controlling an image forming apparatus according to claim 3, wherein the both-surface targeted conditions include conditions that the area ratio at which the first drawing region occupies the first reading surface exceeds the first surface reference ratio and that the area ratio at which the second drawing region occupies the second reading surface falls below the predetermined second surface reference ratio, and
in a case where the second drawing region is present on the second reading surface of the both-surface targeted document, the both-surface pattern print processing includes processing in which in each of a region overlapping the first drawing region of the first reading surface on the second reading surface of the both-surface targeted document and a region including the second drawing region on the second reading surface of the both-surface targeted document, the first pattern image is formed and processing in which in a region including the first drawing region on the first reading surface of the both-surface targeted document, the second pattern image is formed.

6. The method for controlling an image forming apparatus according to claim 3, further comprising
the processor identifying, from the plurality of documents, one-surface targeted document as to which images in the first drawing region and the second drawing region satisfy predetermined one-surface targeted conditions and
the processor causing the printing apparatus to execute one-surface pattern print processing in which in a region including the first drawing region on the first reading surface of the one-surface targeted document, the second pattern image is further formed without forming any image on the second reading surface of the one-surface targeted document, wherein
the one-surface targeted conditions are conditions that the area ratio at which the first drawing region occupies the first reading surface falls below the first surface reference ratio and that the second drawing region is not present.

7. The method for controlling an image forming apparatus according to claim 1, wherein in a manner different from a manner of processing in which the both-surface targeted document is discharged in the both-surface pattern print processing, the processor causes the printing apparatus to execute discharge processing of the non-target document in the idle feed processing.

8. The method for controlling an image forming apparatus according to claim 1, further comprising the processor outputting guide information through an information output device after causing the image reading apparatus to execute the both-surface reading processing, wherein
the guide information is information which guides placement of the plurality of documents targeted for the both-surface reading processing on the sheet placing portion with the first reading surface of each of the plurality of documents being the second surface of each of the plurality of sheets.

9. An image forming apparatus comprising:
a printing apparatus being operable to execute both-surface print processing;
an image reading apparatus being operable to execute both-surface reading processing; and
a processor configured to execute the method for controlling an image forming apparatus according to claim 1, wherein
in the both-surface print processing, while the printing apparatus is conveying a plurality of sheets placed on a sheet placing portion one by one, the printing apparatus sequentially forms images on a first surface and a second surface of each of the sheets by an ink-jet method and further discharges each of the sheets onto a sheet discharge portion, and
in the both-surface reading processing, the image reading apparatus reads images on both surfaces of each of a plurality of documents.
